(19) United States
(12) Patent Application Publication
(10) Pub. No.: US 2005/0122852 A1
(43) Pub. Date: Jun. 9, 2005

(54) Information storage medium capable of restricting number of times that data can be reproduced, method and apparatus for recording data on the information storage medium, and method and apparatus for reproducing data from the information storage medium

(75) Inventors: Sung-hyu Han, Seoul (KR); Yun-sang Kim, Suwon-si (KR); Yang-lim Choi, Seongnam-si (KR); Yong-kuk You, Suwon-si (KR); Hee-chul Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/002,200

(22) Filed: Dec. 3, 2004

(30) Foreign Application Priority Data
Dec. 5, 2003 (KR) 2003-87977

(51) Int. Cl. G11B 7/085; G11B 7/24

(52) U.S. Cl. 369/30.03; 369/275.3

(57) ABSTRACT

Provided are an information storage medium from which a total number of times that data can be reproduced is limited, a method and apparatus for recording data on the information storage medium, and a method and apparatus for reproducing data from the information storage medium. The information storage medium includes a data zone storing user data, and a control information zone storing control information regarding controlling a number of times that the user data can be reproduced. Accordingly, a content provider who provides content such as a movie can create various types of business models by recording content on the aforementioned information storage medium, and selling it at a cheaper price. Further, control information is recorded on the information storage medium or a write once zone of the information storage medium before recording content or user data thereon, thereby preventing the control information from being changed or deleted.

### BACKGROUND OF THE INVENTION

This application claims the priority of Korean Patent Application No. 2003-87977, filed on Dec. 5, 2003, in the Korean Intellectual Property Office, the disclosures of which is incorporated herein in its entirety by reference.

1. Field of the Invention

The present invention relates to recording data on or reproducing data from an information storage medium, and more particularly, to an information storage medium from which a total number of times data can be reproduced is restricted, a method and apparatus for recording data on the information storage medium, and a method and apparatus for reproducing data from the information storage medium.

2. Description of the Related Art

A conventional information storage medium, such as a compact disc (CD) or a digital versatile disc (DVD), is largely categorized into three types: a Read Only Memory (ROM) type on which only reproduction of data is allowed, a Write Once Read Many (WORM) type on which recording is allowed only once, and a rewritable type on which recording is allowed many times. However, these types are determined by whether data can be recorded or a number of times that data can be recorded thereon, and a number of times that data can be reproduced is not limited. That is, there is no restriction on a number of times that content recorded on a conventional information storage medium can be reproduced until the medium has a defect.

However, as use of information storage media, such as a DVD on which content is recorded, has become widespread, there is a strong need to develop information storage media from which a number of times that content stored can be reproduced is limited. In particular, content providers who manufacture or provide information storage media that store content such as a movie desire to put a restriction to the number of times that content stored in information storage media can be reproduced.

### SUMMARY OF THE INVENTION

The present invention provides an information storage medium from which the number of times that stored data can be reproduced is limited.

The present invention also provides a method and apparatus for reproducing data from an information storage medium from which the number of times that the data can be reproduced is limited.

The present invention also provides a method and apparatus for recording data on an information storage medium such that the number of times that the data can be reproduced is limited.

According to one aspect of the present invention, there is provided an information storage medium comprising a data zone storing user data; and a control information zone storing control information regarding controlling of a number of times that the user data can be reproduced from the data zone.

According to another aspect of the present invention, there is provided a method of recording data on an information storage medium, the method comprising recording user data on the information storage medium; and recording information regarding a total number of times that the user data can be reproduced in a control information zone of the information storage medium.

According to yet another aspect of the present invention, there is provided an apparatus for recording data on an information storage medium, the apparatus comprising a recording/reading unit recording user data on the information storage medium; and a controller controlling the recording/reading unit to record information regarding a total number of times that the user data can be reproduced in a control information zone of the information storage medium.

According to still another aspect of the present invention, there is provided a method of reproducing user data from an information storage medium, the method comprising reading information regarding a total number of times that user data can be reproduced and information regarding a number of times that the user data has been reproduced from a control information zone of an information storage medium; comparing the total number with the number; and reproducing the user data when the total number is greater than the number.

According to still another aspect of the present invention, there is provided an apparatus for reproducing data from an information storage medium, the apparatus comprising a recording/reading unit reading information regarding a total number of times that user data can be reproduced from the information storage medium and information regarding a number of times that the user data has been reproduced, from a control information zone of the information storage medium; and a controller controlling the recording/reading unit to read and reproduce the user data when the total number is greater than the number.

### BRIEF DESCRIPTION OF THE DRAWINGS

The above and other aspects and advantages of the present invention will become more apparent by describing in detail exemplary embodiments thereof with reference to the attached drawings in which:

FIG. 1 illustrates the structure of an information storage medium according to one embodiment of the present invention;

FIG. 2 illustrates the structure of an information storage medium according to another embodiment of the present invention;

FIG. 3 is a block diagram of an apparatus for recording and/or reproducing data according to an embodiment of the present invention;

FIG. 4 is a flowchart illustrating a method of recording data according to an embodiment of the present invention; and

FIG. 5 is a flowchart illustrating a method of reproducing data according to an embodiment of the present invention.

### DETAILED DESCRIPTION OF THE INVENTION

In the present invention, information regarding a total number of times that data can be reproduced from an information storage medium and information regarding a number of times that the data has been reproduced, are recorded on the information storage medium such that these information cannot be deleted or changed. A reproducing apparatus reads the information from the information storage medium, and reproduces the data from the information storage medium only when the number of times that the data has been reproduced is less than the total number of times that the data can be reproduced.

Hereinafter, exemplary embodiments of the present invention will be described in detail regarding a Read Only Memory (ROM) type medium or a Write Once Read Many (WORM) type medium with reference to the accompanying drawings.

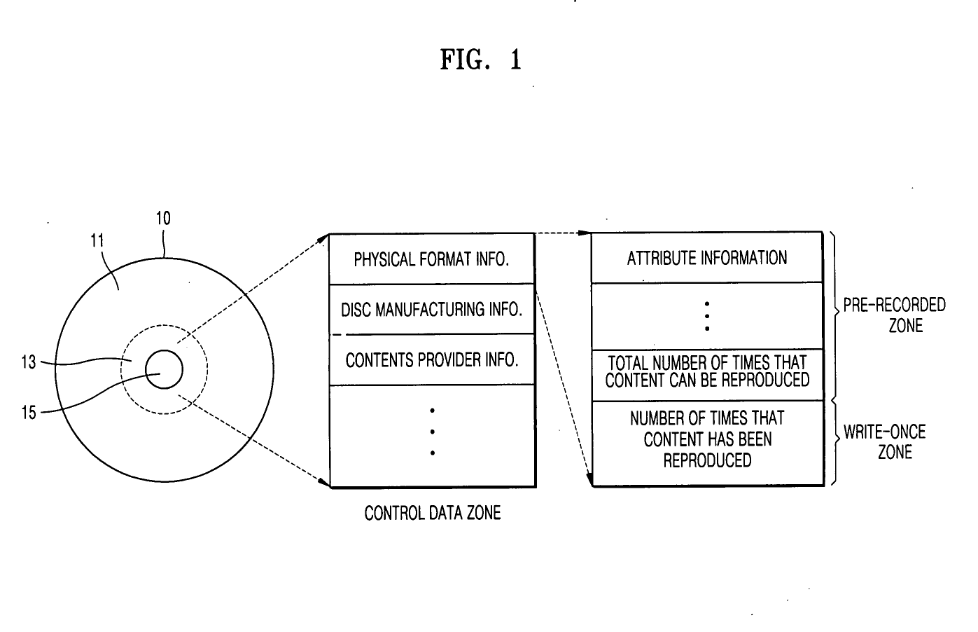

FIG. 1 illustrates the structure of an information storage medium 10 according to an embodiment of the present invention. The information storage medium 10 is a ROM type that includes a data zone 11 that stores user data, such as audio/video (AV) content, and a lead-in zone 13 that stores various control information regarding the use of the information storage medium 10. A center hole 15 is formed at the center of the information storage medium 10.

In general, an information storage medium includes a control information zone, such as a lead-in zone or an inner region, on which various control information regarding the use of the information storage medium is recorded. Referring to FIG. 1, the lead-in zone 13 includes a control data zone. In the control data zone, information, such as physical format information, disc manufacturing information, and content provider information, is recorded. In general, the physical format information specifies the type, size and standard version of an information storage medium. The disc manufacturing information specifies the manufacturer and manufacturing date of the information storage medium. The content provider information specifies a content provider who has provided the content stored in the information storage medium.

The physical format information stored in the information storage medium 10 further includes attribute information regarding the information storage medium 10, information regarding a total number of times that the user data can be reproduced, and information regarding a number of times that the user data has been reproduced. The attribute information specifies that there is a restriction to the total number of times that the user data can be reproduced from the information storage medium 10.

The attribute information and the information regarding the total number of times that the user data can be reproduced, are recorded in a pre-recorded zone before putting the information storage medium 10 on the market, for example, during manufacture of the information storage medium 10 or recording content thereon. It is impossible to delete or change data stored in the pre-recorded zone.

The information regarding the number of times that the user data has been reproduced is updated by a reproducing apparatus whenever a user reproduces the user data using the reproducing apparatus. When this information is updated, it is recorded on a predetermined part of the lead-in zone 13. The predetermined part is preferably, but not necessarily, a write once zone so that data recorded thereon cannot be deleted or changed. In the write once zone, recording of data is allowed only once and the recorded data cannot be deleted or changed.

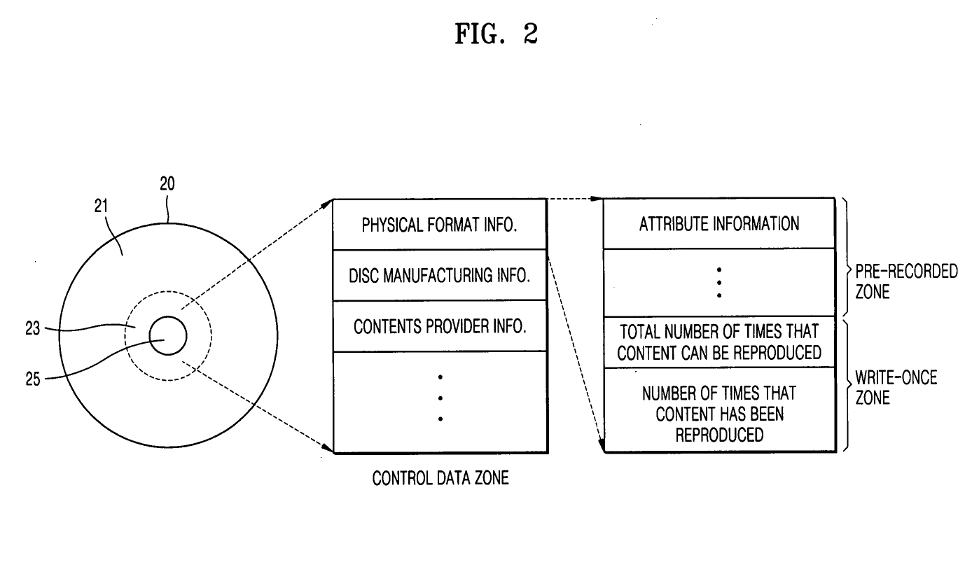

FIG. 2 illustrates the structure of an information storage medium 20 according to another embodiment of the present invention. The information storage medium 20 is a WORM type that includes a data zone 21 that stores user data and a lead-in zone 23 that stores various control information regarding the use of the information storage medium 20. A center hole 25 is formed at the center of the information storage medium 20.

Similar to the information storage medium 10 of FIG. 1, the lead-in zone 23 includes a control data zone on which physical format information, disc manufacturing information, and content provider information are recorded.

The physical format information includes attribute information regarding the information storage medium 20, information regarding a total number of times that the user data can be reproduced from the information storage medium 20, and information regarding a number of times that the user data has been reproduced. The attribute information specifies that there is a restriction to the total number of times that the user data can be reproduced from the information storage medium 10.

The attribute information is recorded before putting the information storage medium 20 on the market, for example, during manufacture of the information storage medium 20 or recording content thereon. In this embodiment, a distributor or a user of the information storage medium 20 is allowed to determine a point of time that recording will be started and the total number of times that the user data can be recorded. In other words, as in the information storage medium 10 of a ROM type shown in FIG. 1, the information regarding the total number of times that the user data can be recorded may be recorded during manufacture of the information storage medium 20. Otherwise, after purchasing the information storage medium 20 wherein the information regarding the total number of times that the user data can be reproduced and content are not recorded, a content provider or the user may determine the total number and record it on the information storage medium 20 before or after recording the content thereon.

The information regarding the number of times that the user data has been reproduced is updated by a reproducing apparatus whenever the user reproduces the user data from the information storage medium 20 using the reproducing apparatus.

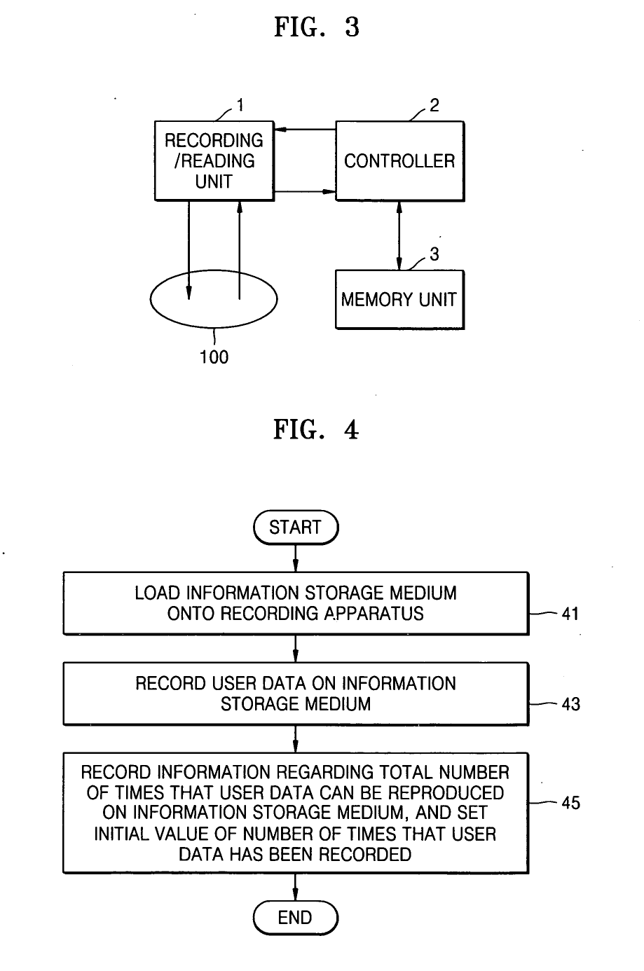

FIG. 3 is a block diagram of an apparatus for recording and/or reproducing data according to an embodiment of the present invention. The apparatus includes a recording/reading unit 1, a controller 2, and a memory unit 3.

The recording/reading unit 1 records data on or reads data from an information storage medium 100 under control of the controller 2. The information storage medium 100 is equivalent to either the information storage medium 10 of FIG. 1 or the information storage medium 20 of FIG. 2.

The controller 2 controls the recording/reading unit 1 to record information regarding a total number of times that data can be reproduced on the information storage medium 100 so as to put a restriction to the number of times that the data can be reproduced. Also, during a read operation, the controller 2 limits the number of times that data can be reproduced, based on the information regarding the number of times that data can be reproduced and the number of times that the data has been reproduced, these information being recorded on the information storage medium 100.

The memory unit 3 temporarily stores data that will be recorded on the information storage medium 100, and stores data read from the information storage medium 100.

A method of recording data according to an embodiment of the present invention will now be described.

FIG. 4 is a flowchart illustrating a method of recording data according to an embodiment of the present invention. The method of FIG. 4 is performed using the information storage medium 100 equivalent to the information storage medium 20 of a WORM type, shown in FIG. 2, on which information regarding the total number of times that data can be reproduced and content are not recorded. That is, the information storage medium 20 is blank. After purchasing the information storage medium 20, a content provider or a user can determine the total number of times that data can be reproduced and record it on the information storage medium 20 before or after recording content thereon.

In the method, when the information storage medium 20 on which the content or user data is not recorded is loaded onto a recording apparatus (operation 41), the recording apparatus records the content or the user data on the information storage medium 20 (operation 43).

Next, information regarding the total number of times that the content or the user data can be reproduced is recorded on the information storage medium 20, and an initial value of the number of times that the content or the user data has been recorded is set (operation 45). Since the initial value may be set during manufacture of the information storage medium 20, setting of the initial value may be omitted from the method.

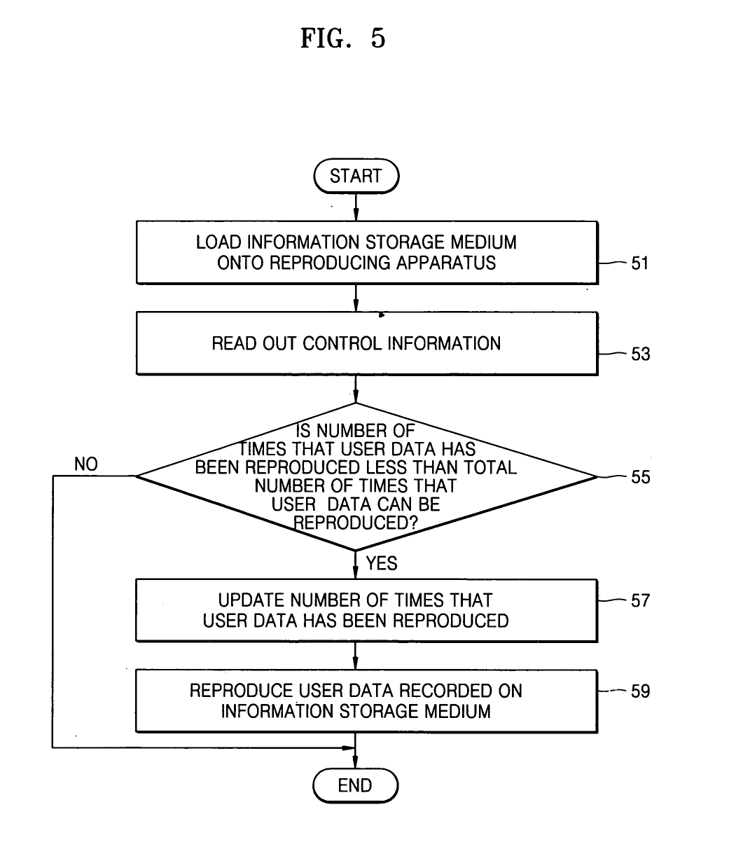

FIG. 5 is a flowchart illustrating a method of reproducing data according to an embodiment of the present invention. The method of FIG. 5 may be performed using the information storage medium 100 equivalent to either the information storage medium 10 of a ROM type shown in FIG. 1 or the information storage medium 20 of a WORM type shown in FIG. 2. In this embodiment, the total number of times that data can be reproduced has been recorded on the information storage medium 100 before a content provider or a user purchases it.

In the method, when the information storage medium 100 on which content or user data is recorded is loaded onto a reproducing apparatus (operation 51), the reproducing apparatus reads control information from a control information zone such as a lead-in zone or an inner region (operation 53). As shown in FIG. 1, the control information includes information such as physical format information, disc manufacturing information, or content provider information. The physical format information includes attribute information regarding the information storage medium 100, information regarding the total number of times that the content or the user data can be reproduced, and information regarding the number of times that the content or the user data has been reproduced.

Next, a controller, such as that shown in the controller 2 of FIG. 3, which is installed in the reproducing apparatus compares the total number of times that the content or the user data can be reproduced with the number of times that the content or the user data has been reproduced, and determines whether the number is less than the total number (operation 55).

If the number is less than the total number, the information regarding the number stored in a predetermined part of the control information zone of the information storage medium 100 is updated (operation 57), and the content or the user data is reproduced from the information storage medium 100 (operation 59). However, when the number is equal to or greater than the total number, the method of FIG. 5 is completed without reproducing the content or the user data from the information storage medium 100.

The present invention can be embodied as a computer readable code in a computer readable medium. Here, the computer readable medium may be any recording apparatus capable of storing data that is read by a computer system, e.g., a read-only memory (ROM), a random access memory (RAM), a compact disc (CD-ROM), a magnetic tape, a floppy disk, an optical data storage device, and so on. Also, the computer readable medium may be a carrier wave that transmits data via the Internet, for example. The computer readable recording medium can be distributed among computer systems that are interconnected through a network, and the present invention may be stored and implemented as a computer readable code in the distributed system.

As described above, according to the present invention, it is possible to limit a total number of times that content can be reproduced from an information storage medium. Accordingly, a content provider who provides content such as a movie can create various types of business models by recording the content on an information storage medium according to the present invention and selling it at a cheaper price. Further, according to the present invention, a total number of times of which the content can be reproduced must be limited, is recorded on an information storage medium or a write once zone of the information storage medium before recording content or user data thereon, thereby preventing the information from being changed or deleted.

While this invention has been particularly shown and described with reference to exemplary embodiments thereof, it will be understood by those skilled in the art that various changes in form and details may be made therein without departing from the spirit and scope of the invention as defined by the appended claims.

1. An information storage medium comprising:
a data zone storing user data; and
a control information zone storing control information regarding controlling a number of times that the user data can be reproduced from the data zone.

2. The information storage medium of claim 1, wherein the control information comprises:
attribute information specifying an attribute of the information storage medium from which a total number of times that the user data can be reproduced is limited;
information regarding the total number of times that the user data can be reproduced; and
information regarding a number of times that the user data has been reproduced.

3. The information storage medium of claim 2, wherein the control information zone comprises a write once zone on which the information regarding the number of times that the user data has been reproduced is recorded.

4. The information storage medium of claim 2, wherein the information regarding the total number of times that the user data can be reproduced is recorded on the control information zone outside the write once zone before the user data is recorded.

5. The information storage medium of claim 2, wherein the information regarding the total number of times that the user data can be reproduced is recorded on the write once zone.

6. The information storage medium of claim 2, wherein the information regarding the number of times that the user data has been reproduced is updated whenever the user data is reproduced.

7. The information storage medium of claim 1, wherein the information storage medium is a write once type information storage medium.

8. A method of reproducing user data from an information storage medium, comprising:
reading information regarding a total number of times that user data can be reproduced and information regarding a number of times that the user data has been reproduced from a control information zone of an information storage medium;
comparing the total number of times that user data can be reproduced with the number of times that the user data has been reproduced; and
reproducing the user data when the total number of times that user data can be reproduced is greater than the number of times that the user data has been reproduced.

9. The method of claim 8, wherein the information regarding the total number of times that the user data can be reproduced is recorded on a pre-recoded zone of the control information zone, and the information regarding the number of times that the user data has been reproduced is recorded on a write once zone of the control information zone.

10. The method of claim 8, wherein the information regarding the total number of times that the user data can be reproduced and the information regarding the number of times that the user data has been reproduced are recorded on a write once zone of the control information zone.

11. The method of claim 9, wherein in the pre-recorded zone, predetermined data is recorded during a manufacture of the information storage medium or during a recording of the user data, and the recorded predetermined data is not allowed to be deleted or changed.

12. The method of claim 9, wherein in the write once zone, a recording of data is allowed only once and the recorded data is not allowed to be deleted or changed.

13. The method of claim 8, wherein the method of reproducing data is performed when attribute information is read from the control information zone, the attribute information specifying an attribute of the information storage medium from which the total number of times that the user data can be reproduced is limited.

14. The method of claim 8, wherein the information storage medium is a write once information storage medium.

15. A method of recording data on an information storage medium, comprising:
recording user data on the information storage medium; and
recording information regarding a total number of times that the user data can be reproduced in a control information zone of the information storage medium.

16. The method of claim 15, further comprising recording an initial value of 0 as a number of times that the user data has been reproduced.

17. The method of claim 15, wherein the information storage medium is a write once type information storage medium.

18. An apparatus for reproducing data from an information storage medium, comprising:
a recording/reading unit reading information regarding a total number of times that user data can be reproduced from the information storage medium and information regarding a number of times that the user data has been reproduced, from a control information zone of the information storage medium; and
a controller controlling the recording/reading unit to read and reproduce the user data when the total number of times that user data can be reproduced from the information storage medium is greater than the number of times that the user data has been reproduced.

19. The apparatus of claim 18, wherein the information regarding the total number of times that the user data can be reproduced is recorded on a pre-recorded zone of the control information zone, and the information regarding the number of times that the user data has been reproduced is recorded on a write once zone of the control information zone.

20. The apparatus of claim 18, wherein the information regarding the total number of times that user data can be reproduced and the information regarding the number of times that the user data has been reproduced are recorded on a write once zone of the control information zone.

21. The apparatus of claim 19, wherein in the pre-recorded zone, predetermined data is recorded during a manufacture of the information storage medium or during a recording of the user data, and the recorded predetermined data is not allowed to be deleted or changed.

22. The apparatus of claim 19, wherein in the write once zone, a recording of data is allowed only once, and the recorded data is not allowed to be deleted or changed.

23. The apparatus of claim 19, wherein the controller controls the recording/reading unit to read the information regarding the total number of times that the user data can be reproduced and the information regarding the number of times that the user data has been reproduced when attribute information is read from the control information zone, the attribute information specifying an attribute of the information storage medium from which a number of times that the user data can be reproduced is limited.

24. The apparatus of claim 18, wherein the information storage medium is a write once type information storage medium.

25. An apparatus for recording data on an information storage medium, comprising:
a recording/reading unit recording user data on the information storage medium; and
a controller controlling the recording/reading unit to record information regarding a total number of times that the user data can be reproduced in a control information zone of the information storage medium.

26. The apparatus of claim 25, wherein the controller controls the recording/reading unit to record an initial value of 0 as a number of times that the user data has been reproduced on the control information zone.

27. The apparatus of claim 25, wherein the information storage medium is a write once type information storage medium.

28. A computer readable recording medium for recording a program which executes a method of reproducing user data from an information storage medium, wherein the method comprises:
reading information regarding a total number of times that the user data can be reproduced and information regarding a number of times that the user data has been reproduced, from a control information zone of the information storage medium;
comparing the total number of times that the user data can be reproduced with the number of times that the user data has been reproduced; and
reproducing the user data when the total number of times that the user data can be reproduced is greater than the number of times that the user data has been reproduced.

29. A computer readable recording medium for recording a program which executes a method of reproducing data from an information storage medium, wherein the method comprises:
recording user data on the information storage medium; and
recording information regarding a total number of times that the user data can be reproduced on a control information zone of the information storage medium.
